(19) United States
(12) Patent Application Publication
(10) Pub. No.: US 2006/0283231 A1
(43) Pub. Date: Dec. 21, 2006

(54) Signal adjustment circuit with reference circuit

(76) Inventors: Hung-Yi Kuo, Hsin-Tien City (TW); Hui-Mei Chen, Hsin-Tien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/259,046

(22) Filed: Oct. 27, 2005

(30) Foreign Application Priority Data
Jun. 21, 2005 (TW) 094120617

(51) Int. Cl. G01F 25/00

(52) U.S. Cl. 73/1.34

(57) ABSTRACT

A signal adjustment circuit with a reference circuit is proposed in the present invention. The signal adjustment circuit is used to adjust a setting value of a first chip or a second chip. The first chip provides an output signal corresponding to an output value according to the setting value thereof. The second chip receives the output signal of the first chip according to the setting value thereof. The reference circuit has multiple reference voltages and compares the output signal of the first chip with the reference voltages to produce multiple comparison values. The comparison values are then passed to the decision unit. After that, the decision unit checks the comparison values according to the output value and produces an adjustment signal to adjust the setting value of the first chip or the second chip. In this way, the stability of transmission between the first and second chips is maintained.

### BACKGROUND OF THE INVENTION

1. Field of the Invention

The present invention is related to signal adjustment, and more particularly, to a signal adjustment circuit for signal transmission between chips.

2. Description of Related Art

Recently, with the rapid development of technology industries, many technical products are updated faster and faster. Hence, the speed of introducing new products into the market is increased dramatically. In order to provide more functions, most technical products, such as computer systems, need to be equipped with more micro-processing chips. To make sure that the chips can work normally and prevent signals transferred between chips from being affected by the circuit arrangement of the circuit board, technical products need to be tested and adjusted before be marketed. Thus, in order to meet the requirements of speedy production of new products, test and adjustment of chips should be competed in a short time period.

When signals are transferred between chips, the chip that receives the signals compares the received signals with a reference voltage to determine the data conveyed by the signals. For example, if the amplitude of the signal is larger than the reference voltage, the chips determines that the data “1” is conveyed by the signal; otherwise, if the amplitude of the signal is smaller than the reference voltage, the chips determines that the data “0” is conveyed by the signal. In general, when a tester finds that the signal transmission between chips is erroneous, he will use an auxiliary instrument to check the pins of the chip to measure the voltage of the received signals. Then, he will manually adjust the driving voltage of the chip that sends the signals or adjust the reference voltage of the chip that receives the signals until the signal transmission between the chips is correct. Moreover, the erroneous transmission between the chips may be caused because the transmission timing or the reception time of the chips is wrong. Hence, the tester needs to manually adjust the transmission time or the reception time to make the signal transmission between the chips correct.

In accordance with the above description, since the chips are adjusted manually in the prior art, the test and adjustment of the chips are not easy to be completed in a short time period. In addition, because the real reason for the erroneous transmission is not easy to be found, the proper adjustment is hard to be achieved. It results in the waste of time, and thus the production efficiency of new products is low. Hence, the competitiveness is reduced and transmission errors are easy to occur.

Furthermore, the chip only uses a reference voltage for comparison with the received signals and thus obtains the data conveyed by them. Hence, the chip determines the data conveyed by the received signal is “1” when the amplitudes of the signal is larger than the reference voltage, no matter how much the amplitude of the signal exceeds the reference voltage. Thus, in the test procedure, the tester will consider that the chip is okay when the amplitude of the received signal only exceeds the reference voltage a little. In this situation, the operation of the chip is easy to be affected by environment because the amplitude of the signal is usually reduced during transmission due to, for example, temperature or electromagnetic interference when in use. So, the amplitude of the signal that is originally larger than the reference voltage may become lower than it due to the affection of environment. Hence, the chip is easy to operate abnormally.

Aiming to resolve the problem mentioned above, a signal adjustment circuit with a reference circuit is proposed in the present invention. It is not only able to check precisely whether the signal transmission between chips is correct or not, but also to adjust the settings of the chips in a short time period. Thus, the test efficiency of chips is improved, the time consumption of test is reduced, and the competitiveness of the new products is increased.

### SUMMARY OF THE INVENTION

An objective of the present invention is to provide a signal adjustment circuit with a reference circuit for improving the stability of signal transmission between chips.

Another objective of the present invention is to provide a signal adjustment circuit with a reference circuit and a decision unit for reducing time consumption of signal adjustment between chips.

The reference circuit of the present invention has a plurality of comparators. Each of the comparators has a reference voltage. The comparators compare the input signal respectively with the reference voltages to produce a plurality of comparison values to check whether the input signal is correct or not.

The signal adjustment circuit of the present invention is used to adjust a setting value of a first chip or a second chip. The signal adjustment circuit has a reference circuit and a decision unit. The first chip provides an output signal corresponding to an output value according to the setting value thereof. The second chip receives the output signal of the first chip according to the setting value thereof. The reference circuit has a plurality of reference voltages. Therein the reference circuit compares the output signal of the first chip with the reference voltages to produce a plurality of comparison values. The comparison values are then passed to the decision unit. After that, the decision unit checks the comparison values according to the output value and thereby determines whether the output signal of the first chip is correct or not. If the output signal of the first chip is erroneous, the decision unit produces an adjustment signal to adjust the setting value of the first chip or the second chip. In this way, the correctness of transmission between the two chips is maintained.

The above summaries are intended to illustrate exemplary embodiments of the invention, which will be best understood in conjunction with the detailed description to follow, and are not intended to limit the scope of the appended claims.

### BRIEF DESCRIPTION OF THE DRAWINGS

The features of the invention believed to be novel are set forth with particularity in the appended claims. The invention itself however may be best understood by reference to the following detailed description of the invention, which describes certain exemplary embodiments of the invention, taken in conjunction with the accompanying drawings, in which:

FIG. 1 is a block diagram of a preferred embodiment in accordance with the present invention;

FIG. 2A is a schematic diagram showing two reference voltages and a received signal in accordance with the present invention;

FIG. 2B is a schematic diagram showing two reference voltages and another received signal in accordance with the present invention;

FIG. 2C is a schematic diagram showing two reference voltages and another received signal in accordance with the present invention; and

FIG. 3 is a schematic diagram showing three reference voltages and a received signal in accordance with the present invention.

### DETAILED DESCRIPTION OF PREFERRED EMBODIMENTS

The present invention employs a plurality of reference voltages to check the electric potential of a received signal and performs the following adjustment operation according to the checking result. In this way, the present invention can make a decision more correctly.

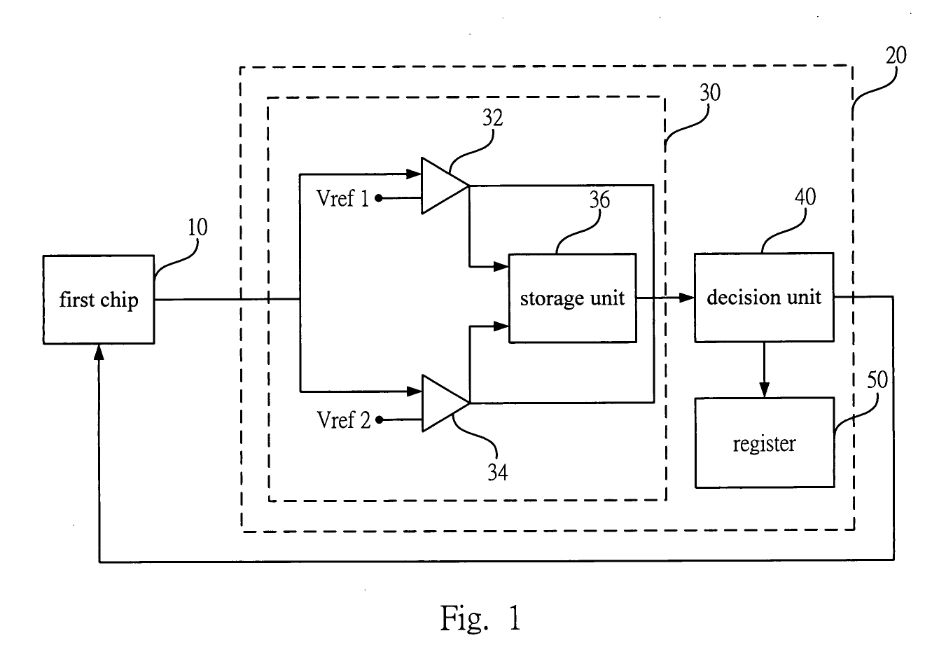

Reference is made to FIG. 1, which is a block diagram of a preferred embodiment in accordance with the present invention. The present invention is used to check and adjust the operation of signal transmission between the first chip 10 and the second chip 20. Therein, the second chip 20 includes a reference circuit 30 and a decision circuit 40. The combination of the reference circuit 30 and the decision circuit 40 forms the signal adjustment circuit of the present invention. The decision circuit 40 can be built in the first chip 10. The decision circuit 40 can be realized as a program. The reference circuit 30 includes a first comparator 32 and a second comparator 34. The first comparator 32 has a first reference voltage Vref1 while the second comparator 34 has a second reference voltage Vref2. The first reference voltage Vref1 is higher than the second reference voltage Vref2. The second reference voltage Vref2 is a general reference voltage. Furthermore, the reference circuit 30 can have a storage unit 36 to store a plurality of comparison values produced by the comparators 32, 34, so the decision unit 40 can access the storage unit 36 to obtain the comparison values. The storage unit 36 can be a register. The first chip 10 provide an output signal corresponding to a output value (0 or 1) for the second chip 20 in accordance with a plurality of setting values. The output value is a pre-setting value. The setting values can include a driving voltage or output timing for transmission of the output signal.

The second chip 20 receives the output signal sent from the first chip 10 according to its setting values. The setting values of the second chip 20 include reception timing. The signal received by the second chip 20 is passed to the reference circuit 30. The first comparator 32 of the reference circuit 30 compares the first reference voltage Vref1 with the received signal while the second comparator 34 compares the second reference voltage Vref2 with the received signal. Thereby, the first comparator 32 and the second comparator 34 provide a first comparison value and a second comparison value to compare with the output value to determine whether the received signal is correct or not. The output value is a pre-setting value. If the received signal is erroneous, the decision unit 40 sends an adjustment signal to the first chip 10 to adjust the setting values of the first chip 10 or to the second chip 20 to adjust the setting values of the second chip 20 or the reference voltages of the reference circuit 30. Such as the decision circuit 40 sends the adjustment signal to adjust the setting values of the second chip 20 which save into a register 50 of the second chip 20.

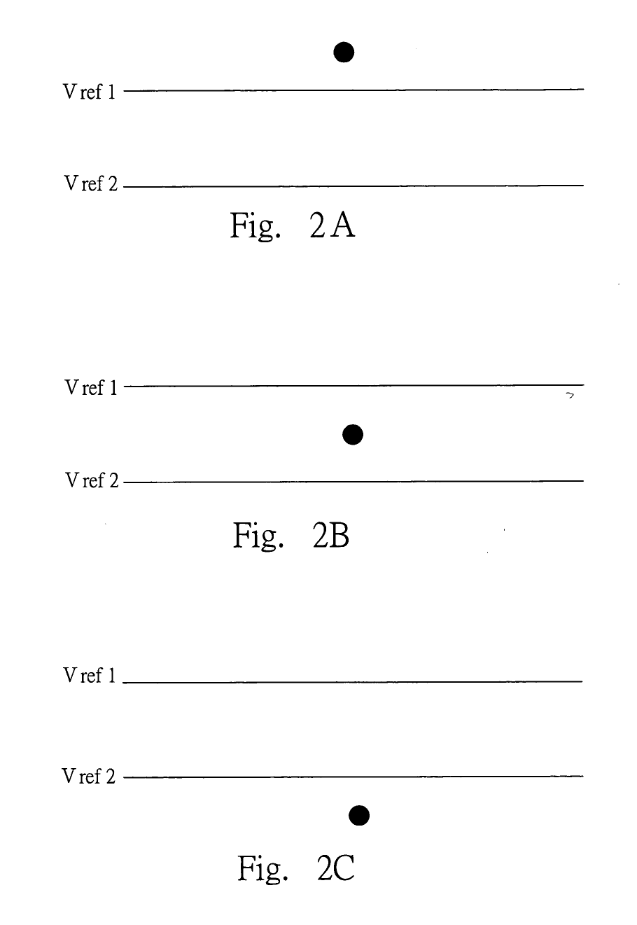

Reference is made to FIG. 2A, which is a schematic diagram showing reference voltages and a received signal in accordance with the present invention. As shown in FIG. 2A, when the received signal has an electric potential higher than the first reference voltage Vref1 and the second reference voltage Vref2, both of the first comparison value and the second comparison value are “1”. After the comparison values are obtained, the decision circuit 40 checks the first comparison values and the second comparison value according to the output value.

If the output value is “1”, i.e. both the first comparison value and the second comparison value are the same as the output value, the decision unit 40 determines the received signal is correct and doesn't send out the adjustment signal. However, if the output value is “0”, the decision unit 40 determines both first comparison values and the second comparison value are different to the output value. Hence, the decision unit 40 sends out an adjustment signal to the first chip 10 and thus adjusts the setting values of the first chip 10 to lower the driving voltage. Each time the driving voltage can be reduced to the original value minus a quarter of the difference between first reference voltage Vref1 and the second reference voltage Vref2. The driving voltage is reduced again and again until the decision unit 40 determines that the first comparison value and the second comparison value are the same as the output value.

Reference is also made to FIG. 2B, which is a schematic diagram showing reference voltages and another received signal in accordance with the present invention. As shown in FIG. 2B, when the received signal has an electric potential located between the first reference voltage Vref1 and the second reference voltage Vref2, the first comparison value is “0” and the second comparison value is “1”. The first comparison value and the second comparison value are passed to the decision unit 40. After receiving the comparison values, the decision circuit 40 checks the first comparison value and the second comparison value according to the output value.

If the output value is “1”, i.e. the first comparison value is different to the output value, the decision unit 40 sends out an adjustment signal to the first chip 10 and thus adjusts the setting values of the first chip 10 to increase the driving voltage. Each time the driving voltage can be increased to the original value plus a quarter of the difference between first reference voltage Vref1 and the second reference voltage Vref2. The driving voltage is increased again and again until the received signal has an electric potential higher than the first reference voltage Vref1.

However, if the output value is “0”, the decision unit 40 determines the second comparison value is different to the output value. Hence, the decision unit 40 sends out an adjustment signal to the first chip 10 and thus adjusts the setting values of the first chip 10 to lower the driving voltage. Each time the driving voltage can be reduced to the original value minus a quarter of the difference between first reference voltage Vref1 and the second reference voltage Vref2. The driving voltage is reduced again and again until the received signal has an electric potential lower than the second reference voltage Vref2.

In this way, the present invention can prevent the signal transmission stability of the first chip 10 from being affected by external factors.

According to the above embodiment, when the output value is “1”, the received signal should be “1” since the reference voltage set inside the first chip 10 is the same as the second reference voltage Vref2. However, the voltage of the signal outputted from the first chip 10 may be reduced due to some reasons and thus is located between the first reference voltage Vref1 and the second reference voltage Vref2, so a signal transmission error occurs. According to the two comparison values provided by the reference circuit 30, a tester can determine the voltage of the received signal and makes the first chip 10 to increase its driving voltage. In this way, the voltage of the received signal can be adjusted to be higher than the first reference voltage Vref1. Thus, even though the voltage of the signal outputted from the first chip 10 is reduced due to some unknown reasons, it can still be kept higher than the second reference voltage Vref2, i.e. higher than the original reference voltage of the first chip 10. Thereby, the signal transmission error is avoided.

Reference is made to FIG. 2C, which is a schematic diagram showing reference voltages and another received signal in accordance with the present invention. As shown in FIG. 2C, when the received signal has an electric potential lower than the first reference voltage Vref1 and the second reference voltage Vref2, both of the first comparison value and the second comparison value are “0”. After receiving the comparison values, the decision circuit 40 checks the first comparison values and the second comparison value according to the output value.

If the output value is “1”, the decision unit 40 determines the received signal is erroneous and sends an adjustment signal to the first chip 10 to increase the driving voltage. Each time the driving voltage can be increased to the original value plus a quarter of the difference between first reference voltage Vref1 and the second reference voltage Vref2. The driving voltage is increased again and again until the voltage of the received signal is higher than the first reference voltage Vref1 and the second reference voltage Vref2. However, if the output value is “0”, the decision unit 40 determines both first comparison values and the second comparison value are the same as the output value. Hence, the decision unit 40 doesn't send an adjustment signal to the first chip 10.

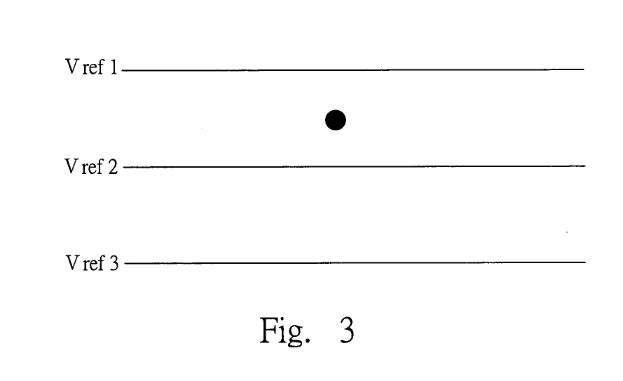

In order to determine the potential of the received signal more precisely, the prevent invention can include a reference circuit having at least three comparators. Reference is made to FIG. 3, which is a schematic diagram showing three reference voltages and a received signal in accordance with the present invention. If the received signal has an electric potential located between the first reference voltage Vref1 and the second reference voltage Vref2, the first comparison value is “0” and the second and third comparison values are “1”. The first comparison value, the second comparison value, and the third comparison value are passed to the decision unit 40. After receiving the comparison values, the decision circuit 40 checks the first comparison value, the second comparison value, and the third comparison value according to the output value.

If the output value is “1”, i.e. the first comparison value is different to the output value, the decision unit 40 sends out an adjustment signal to the first chip 10 and thus adjusts the setting values of the first chip 10 to increase the driving voltage. Each time the driving voltage can be increased to the original value plus a quarter of the difference between first reference voltage Vref1 and the second reference voltage Vref2. The driving voltage is increased again and again until the received signal has an electric potential higher than the first reference voltage Vref1. In this way, signals can be successfully transmitted from the first chip 10 to the second chip 20 and the stability of transmission between the chips can thus be improved.

In the previous embodiments, if the driving voltage are adjusted several times and the comparison values are still not the same as the output value, the decision unit 40 determines that the problem may not occur in the driving voltage, but in the output timing of the first chip 10 or the reception timing of the second chip 20. Hence, the decision unit 40 further sends an adjustment signal to the first chip 10 to adjust the output timing of the fist chip 10, to the second chip 20 to adjust the reception timing of the second chip 20, or to the reference circuit 30 to adjust the reference voltages of the reference circuit 30 so as to make signals be successfully transmitted.

To sum up, the reference circuit of the present invention includes a plurality of comparators. Each of the comparators compares the received signal with a different reference voltage. Because the reference circuit uses a plurality of different reference voltages to compare with the received signal, the decision unit of the present invention can determine the electric potential of the received signal more precisely. That is beneficial for adjustment of the settings of the two chips. The reference circuit further includes a storage unit, which is used to store the comparison values. The decision unit of the signal adjustment circuit checks the comparison values according to the output value to determine whether the received signal is correct or not. The decision unit adjusts the settings of the fist chip or the second chip or the reference voltages of the reference circuit according to the checking result. Since the present invention can automatically perform the checking and adjustment operations, the time consumption for adjustment of the chips is reduced effectively.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are embraced within the scope of the invention as defined in the appended claims.

What is claimed is:

1. A signal adjustment circuit, used to adjust a setting value of a first chip or a second chip, the first chip providing an output signal corresponding to an output value according to the setting value, the second chip receiving the output signal of the first chip according to the setting value, the signal adjustment circuit comprising:
a reference circuit having a plurality of reference voltages, wherein the reference circuit compares the output signal of the first chip with the reference voltages to produce a plurality of comparison values; and
a decision unit checking the comparison values according to the output value and thereby producing an adjustment signal to adjust the setting value.

2. The signal adjustment circuit as claimed in claim 1, wherein the setting value of the first chip is a driving voltage for transmission of the output signal.

3. The signal adjustment circuit as claimed in claim 1, wherein the setting value of the first chip is output timing for transmission of the output signal.

4. The signal adjustment circuit as claimed in claim 1, wherein the setting value of the second chip is reception timing for receiving the output signal of the first chip.

5. The signal adjustment circuit as claimed in claim 1, wherein the adjustment signal of the decision unit is used to adjust the reference voltages of the reference circuit.

6. The signal adjustment circuit as claimed in claim 1, wherein the reference circuit further comprises a plurality of comparators, and the comparators compares the output signal of the first chip with the reference voltages to produce the comparison values.

7. The signal adjustment circuit as claimed in claim 1, wherein the reference circuit further comprises at least a storage unit to store the comparison values.

8. The signal adjustment circuit as claimed in claim 1, wherein the first chip is a South-Bridge chip.

9. The signal adjustment circuit as claimed in claim 1, wherein the second chip is a North-Bridge chip.

10. A reference circuit, used to check an input signal received by a chip, the reference circuit comprising:
a plurality of comparators, each of which has a reference voltage, the comparators comparing the input signal respectively with the reference voltages to produce a plurality of comparison values to check whether the input signal is correct or not.

11. The reference circuit as claimed in claim 10, wherein the reference circuit further comprises at least a storage unit to store the comparison values.

12. The reference circuit as claimed in claim 10, wherein the chip is a South-Bridge chip.

13. The reference circuit as claimed in claim 10, wherein the chip is a North-Bridge chip.
